(19) United States
(12) Patent Application Publication
(10) Pub. No.: US 2014/0140665 A1
(43) Pub. Date: May 22, 2014

(54) OPTICAL MODULE AND OPTICAL TRANSCEIVER

(71) Applicant: OCLARO JAPAN, INC., Kanagawa (JP)

(72) Inventors: Mitsuo AKASHI, Fujisawa (JP); Hiroki IRIE, Fujisawa (JP); Hiroyoshi ISHII, Yokohama (JP); Michihide SASADA, Yokosuka (JP)

(73) Assignee: OCLARO JAPAN, INC., Kanagawa (JP)

(21) Appl. No.: 14/070,615

(22) Filed: Nov. 4, 2013

(30) Foreign Application Priority Data
Nov. 16, 2012 (JP) 2012-251987

(51) Int. Cl. G02B 6/42

(52) U.S. Cl. CPC G02B 6/4281
USPC 385/89

(57) ABSTRACT

An optical module includes: an optical module main body including an optical connector to which a communication cable transferring optical signal is connected, and a terminal portion on which a plurality of terminal pads for transmitting and receiving an electric signal for communication using the optical signal are arranged; a lead array including a lead fixing portion that retains a plurality of metal leads arranged in parallel on and protruding from the lead fixing portion and electrically connected to the plurality of terminal pads of the terminal portion; and a flexible printed circuit including a plurality of holes through which the plurality of metal leads penetrate, and wires electrically connected to the metal leads.

### CROSS-REFERENCE TO RELATED APPLICATION

The present application claims priority from Japanese application JP2012-251987 filed on Nov. 16, 2012, the content of which is hereby incorporated by reference into this application.

### BACKGROUND OF THE INVENTION

1. Field of the Invention

The present invention relates to an optical module and an optical transceiver used in optical fiber communication.

2. Description of the Related Art

In telecommunication of the social infrastructure, optical fiber communication capable of achieving larger capacity transmission is more used instead of communication with a metal wire in the past. In a transceiver used in the optical fiber communication, a transmitter optical sub-assembly (TOSA) and a receiver optical sub-assembly (ROSA) are arranged. Such optical modules are being reduced in size, and the transmission capacity thereof is being increased.

JP 2012-047823 A discloses a structure in which a flexible printed circuit is attached to an electrical interface portion of such an optical module main body.

### SUMMARY OF THE INVENTION

In the optical module main body described above, as an electrical interface portion is provided with multiple terminals due to further reduction in size and multichannel integration, there arises a need to reduce the pitch between terminals. When the pitch is reduced, it is inevitably necessary to reduce the width of an electrode pad of the electrical interface portion for attaching the flexible printed circuit to the optical module main body and the width of a metal lead itself attached to the electrode pad.

In the case of a TOSA/ROSA optical module in the past as an example, when the pitch of the metal lead is 0.7 mm, the electrode pad width of the electrical interface portion of a substrate is 0.38 mm and the metal lead width is 0.15 mm. However, when the pitch of the metal lead is reduced to 0.6 mm, the electrode pad width of the electrical interface portion is 0.21 mm. When the metal lead width is reduced in accordance with this configuration, there arises a risk that the metal lead bends or breaks in the manufacturing process such as, for example, connection of the flexible printed circuit. In such a case, the connection of the flexible printed circuit becomes difficult. Moreover, even if the connection can be made, there is a risk that reliability is reduced in connection strength.

The invention has been made in view of the circumstances described above, and it is an object of the invention to provide an optical module in which even when a pitch between terminals of an electrical interface portion is reduced due to a reduction in size or multichannel, a flexible printed circuit is connected with sufficient strength.

An optical module according to an aspect of the invention includes: an optical module main body including an optical connector to which a communication cable transferring optical signal is connected, and a terminal portion on which a plurality of terminal pads for transmitting or/and receiving an electric signal for communication using the optical signal are arranged; a lead array including a lead fixing portion that retains a plurality of metal leads arranged in parallel on and protruding from the lead fixing portion and electrically connected to the plurality of terminal pads of the terminal portion; and a flexible printed circuit including a plurality of holes through which the plurality of metal leads penetrate, and wires electrically connected to the metal leads.

In the optical module according to the aspect of the invention, the plurality of terminal pads may be formed on each of both surfaces of a circuit board, and the plurality of metal leads of the lead array may be fixed to the lead fixing portion in two rows distant from each other by an amount corresponding to the thickness of the circuit board, and electrically connected to the plurality of terminal pads via the plurality of holes of the flexible printed circuit.

In the optical module according to the aspect of the invention, the flexible printed circuit may further include a circular conductive film that is a conductive film formed so as to surround each of the plurality of holes, and the terminal pad of the optical module main body, the metal lead, and the circular conductive film of the flexible printed circuit may be brazed with a conductive member.

In the optical module according to the aspect of the invention, the pitch of the plurality of terminal pads may be 0.6 mm or less.

In the optical module according to the aspect of the invention, the flexible printed circuit may be interposed between the terminal portion and the lead fixing portion.

In the optical module according to the aspect of the invention, the flexible printed circuit may further include one of surfaces on which a wire that transmits at least a high-frequency signal is disposed, and the other surface on which a wire that supplies at least a fixed potential is disposed, the one surface of the flexible printed circuit may be arranged on the terminal portion side, and the other surface may be arranged on the lead fixing portion side.

An optical transceiver according to another aspect of the invention includes: a receiver optical sub-assembly that receives an optical signal and outputs an electric signal; and a transmitter optical sub-assembly that receives an electric signal and outputs an optical signal, wherein any of the receiver optical sub-assembly and the transmitter optical sub-assembly may be any of the optical modules described above.

### BRIEF DESCRIPTION OF THE DRAWINGS

FIG. 1 is a schematic view showing a configuration of an optical transceiver according to an embodiment of the invention.

FIG. 2 is a perspective view showing in an enlarged manner a connecting portion to a receiver flexible printed circuit in a receiver optical sub-assembly of FIG. 1.

FIG. 3 is a side view of the connecting portion between the receiver optical sub-assembly and the receiver flexible printed circuit of FIG. 2.

FIG. 4 is a top view of the connecting portion between the receiver optical sub-assembly and the receiver flexible printed circuit of FIG. 2.

FIG. 5 is a perspective view showing a terminal portion in an enlarged manner.

FIG. 6 is a diagram for explaining definitions of a pitch, a pad width, and a lead width.

FIG. 7 is a diagram showing how the receiver flexible printed circuit is attached to the receiver optical sub-assembly.

FIG. 8 is a diagram showing a modified example of the embodiment of the invention.

### DETAILED DESCRIPTION OF THE INVENTION

Hereinafter, an embodiment of the invention will be described with reference to the drawings. In the drawings, the same or equivalent elements are denoted by the same reference numeral and sign, and redundant description is omitted.

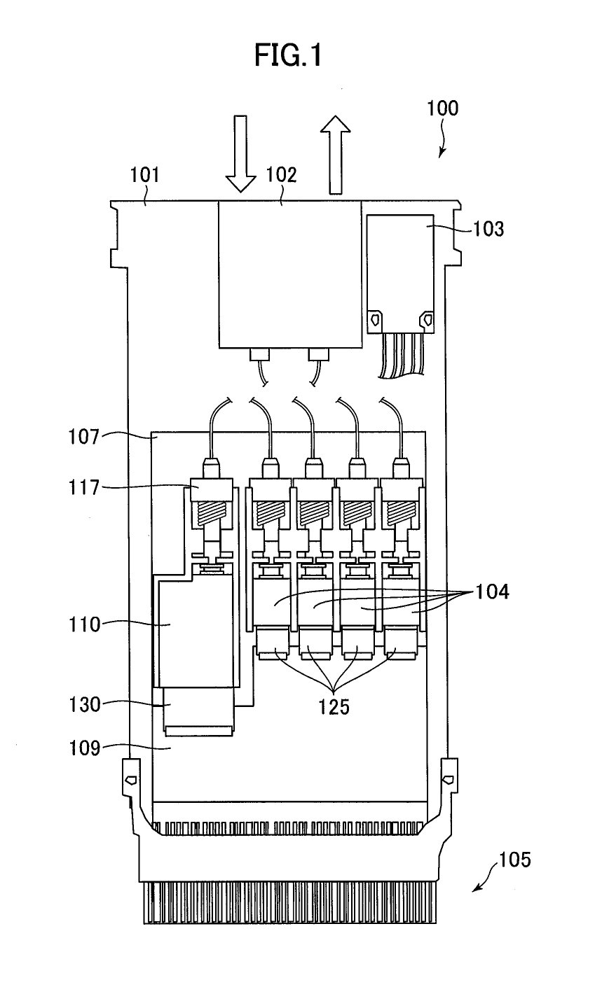

FIG. 1 is a schematic view showing a configuration of an optical transceiver 100 according to the embodiment of the invention. As shown in the drawing, the optical transceiver 100 includes a first substrate 107, an optical filter 103, an optical connector 102 for external connection, and a second substrate 109. The first substrate 107 is a circuit board on which four transmitter optical sub-assemblies (TOSA) 104 that are each an optical module for transmission and one receiver optical sub-assembly (ROSA) 110 that is an optical module for reception are placed. Moreover, the first substrate 107 includes a connecting connector 105 to an external communication controller (not shown). The optical filter 103 combines four channels, when transmitting optical signals output from the four transmitter optical sub-assemblies 104, to form a wavelength-multiplexed signal. The optical connector 102 for external connection is an optical connector for receiving the wavelength-multiplexed signal output from the optical filter 103 and outputting the signal to the outside of the optical transceiver 100, and is an optical connector for receiving an optical signal from the outside. The second substrate 109 secondarily controls the four transmitter optical sub-assemblies 104 and the receiver optical sub-assembly 110. The transmitter optical sub-assemblies 104, the first substrate 107, and the second substrate 109 are connected with transmitter flexible printed circuits 125 that are each a flexible printed circuit, while the receiver optical sub-assembly 110, the first substrate 107, and the second substrate 109 are connected with a receiver flexible printed circuit 130 that is a flexible printed circuit.

Each of the transmitter optical sub-assemblies 104 can perform optical transmission at 25 Gbps, so that four channels of 25-Gbps wavelength-multiplexing communication, that is, optical transmission at 100 Gbps in total is possible by the four transmitter optical sub-assemblies 104. The receiver optical sub-assembly 110 is an integrated device in which four 25-Gbps devices each for one channel are integrated for four channels, so that optical reception at 100 Gbps is possible. However, the embodiment of the invention is not limited thereto. The processing ability per channel, the overall processing ability, and the number of optical modules can be appropriately changed. The transmitter optical sub-assemblies 104 and the receiver optical sub-assembly 110 each include an optical connector 117 for attaching an optical fiber cable.

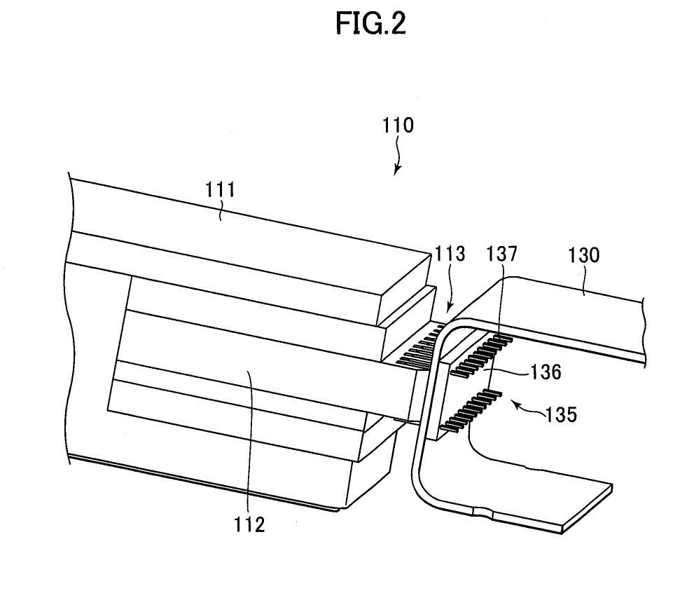

FIG. 2 is a perspective view showing in an enlarged manner a connecting portion to the receiver flexible printed circuit 130 in the receiver optical sub-assembly 110 of FIG. 1. As shown in the drawing, the receiver optical sub-assembly 110 is composed of a receiver optical sub-assembly main body 111, the receiver flexible printed circuit 130, and a lead array 135 connecting the receiver optical sub-assembly main body 111 with the receiver flexible printed circuit 130. The receiver optical sub-assembly main body 111 includes a receiver module substrate 112 having a protruding terminal portion 113. The receiver flexible printed circuit 130 is attached to an edge surface of the receiver module substrate 112 on the terminal portion 113 side such that a substrate surface of the receiver flexible printed circuit 130 is in contact with the edge surface. In this case, the receiver flexible printed circuit 130 is fixed to the edge surface of the receiver module substrate 112 so as to be interposed between the lead array 135 and the edge surface.

The lead array 135 is composed of a plurality of metal leads 137 formed of conductive metal and a lead fixing portion 136 integrally fixing the plurality of metal leads 137. The metal lead 137 is fixed by penetrating into a hole formed in the lead fixing portion 136 made of an insulator such as a resin. In the embodiment, the metal lead 137 penetrates through the lead fixing portion 136 to protrude from both surfaces of the lead fixing portion 136. However, the lead fixing portion 136 may protrude from only one side.

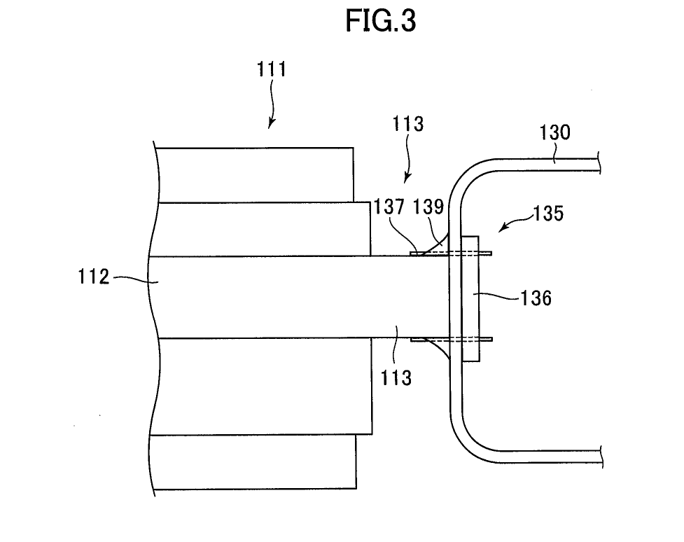

FIG. 3 is a side view of the connecting portion between the receiver optical sub-assembly main body 111 and the receiver flexible printed circuit 130 of FIG. 2. As shown in FIGS. 2 and 3, the metal leads 137 are aligned in two upper and lower rows so as to be able to interpose the receiver module substrate 112 therebetween, and fixed to the lead fixing portion 136. The metal leads 137 are arranged in contact with the terminal portion 113 of the receiver module substrate 112 so as to interpose the terminal portion 113 from both substrate surfaces, and brazed with solder 139 or the like on the terminal portion 113 side. The material used for brazing is generally a material such as Pb—Sn or Sn—Ag—Cu. However, any material can be used as long as it ensures quality needed for connection strength.

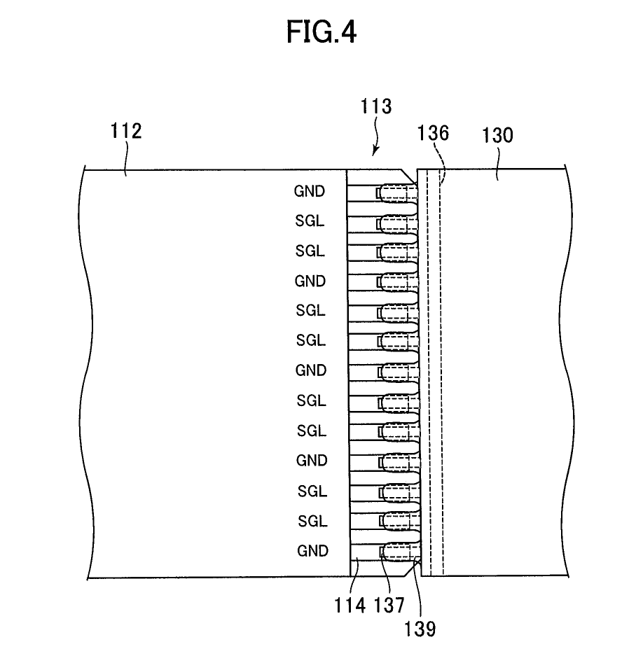

FIG. 4 is a top view of the connecting portion between the receiver optical sub-assembly main body 111 and the receiver flexible printed circuit 130 of FIG. 2. As shown in the drawing, on each of the substrate surfaces of the terminal portion 113 of the receiver module substrate 112, a plurality of terminal pads 114 of ground terminals GND and signal terminals SGL, both of which are electrically connected to the metal leads 137, are arranged in parallel along the edge surface with which the receiver flexible printed circuit 130 is in contact. The metal lead 137 is arranged on each of the terminal pads 114 and brazed thereto with the solder 139 or the like, so that the terminal pad 114, the metal lead 137, and a later-described brazing land 131 that is a circular conductive film of the receiver flexible printed circuit 130 are electrically connected to each other and fixed to each other. The terminal pads 114 in the drawing are arranged assuming that four sets of two signal terminals SGL are provided for four channels. However, any number and arrangement of terminal pads 114 other than those described above may be employed.

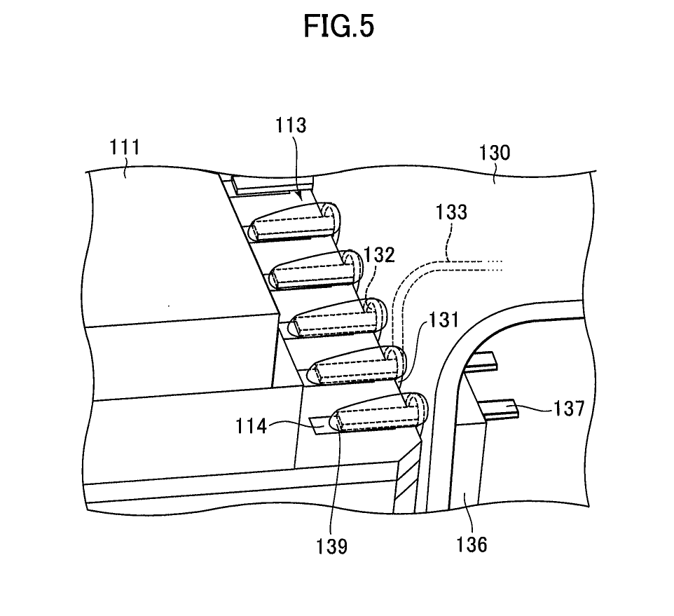

FIG. 5 is a perspective view showing in an enlarged manner the terminal portion 113 to which the receiver flexible printed circuit 130 is connected. As shown in the drawing, in the receiver flexible printed circuit 130, holes 132 are formed corresponding to the metal leads 137 of the lead array 135. The brazing land 131 that is a circular conductive film is formed around the hole 132. The brazing lands 131 are connected to proper wires 133 within the receiver flexible printed circuit 130. Due to this, the solder 139 connects the metal lead 137 with the terminal pad 114, and is further connected to the brazing land 131, thereby fixing the receiver flexible printed circuit 130 and the lead array 135 to the terminal portion 113 as well as establishing electrical connection.

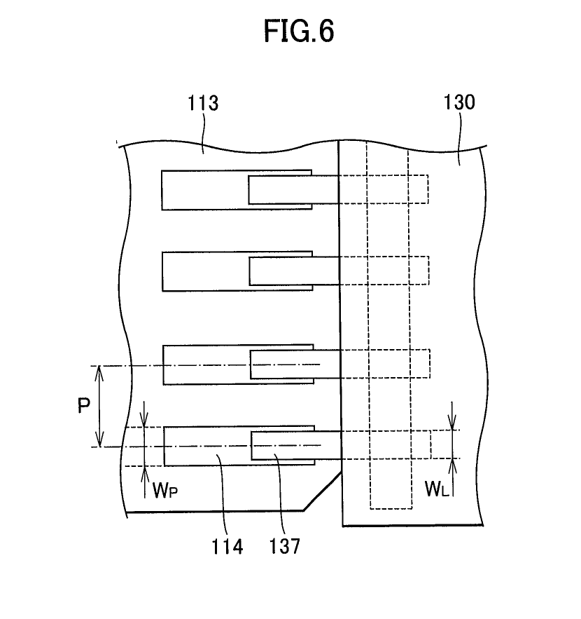

FIG. 6 is a diagram for explaining definitions of a pitch P, a pad width WP, and a lead width WL. In the drawing, the brazing is omitted. As shown in the drawing, the pitch P, the pad width WP, and the lead width WL are respectively defined by lengths, on the substrate surface of the terminal portion 113 of the receiver module substrate 112, in a direction of the edge surface with which the receiver flexible printed circuit 130 is in contact. The pitch P is an arrangement pitch of the terminal pads 114. The pad width WP is the width of the terminal pad 114. The lead width WL is the width of the metal lead 137. For the pad arrangement of high-frequency signals, 13 leads are necessary for four channels when the arrangement of GND-SGL-SGL-GND is employed as shown in FIG. 4. When the lateral width of the terminal portion 113 of the receiver optical sub-assembly 110 is 8 mm, the pitch P is 0.6 mm, and the pad width WP in this case is 0.21 mm. In the embodiment, the lead width WL is set to be from 0.15 to 0.2 mm, thereby ensuring the strength of the metal lead 137 itself. The connection of the embodiment is effective especially when the pitch P is 0.6 mm or less.

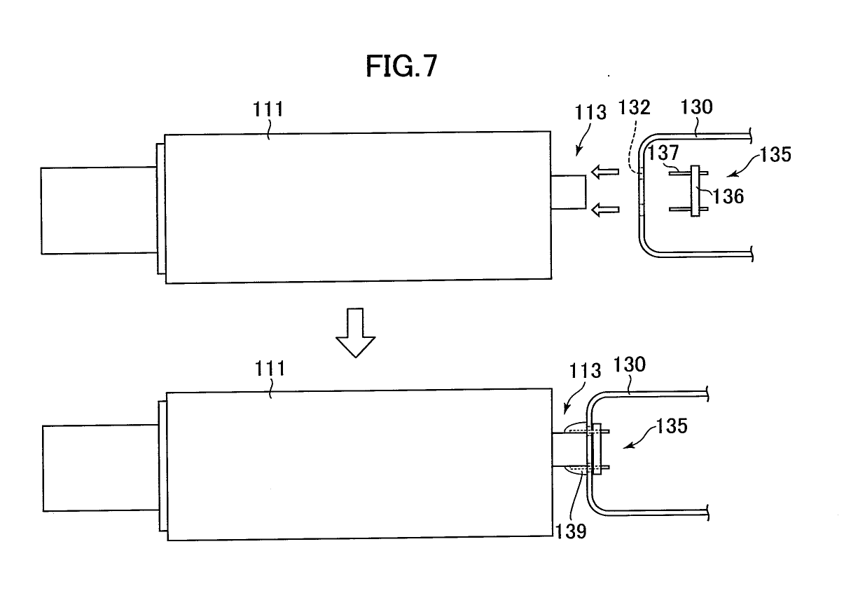

FIG. 7 is a diagram showing how the receiver flexible printed circuit 130 is attached to the receiver optical sub-assembly main body 111. As shown in the drawing, the metal leads 137 of the lead array 135, which are aligned with a width to interpose the terminal portion 113 of the receiver module substrate 112 therebetween, are first attached to the terminal portion 113 via the holes 132 of the receiver flexible printed circuit 130. Next, the solder 139 is flowed from the terminal portion 113 side so as to come into contact with the terminal pad 114, the metal lead 137, and the brazing land 131 for fixing them.

As has been described above, in the receiver optical sub-assembly 110 as an optical module of the embodiment, even when the pitch between the terminal pads of the terminal portion 113 is reduced, a trouble such as bending of the metal lead 137 can be prevented because the metal leads 137 are fixed with the lead fixing portion 136, so that the flexible printed circuit can be connected with sufficient strength. Moreover, since the terminal pad 114, the metal lead 137, and the brazing land 131 can be attached by one brazing, the manufacturing process can be shortened and the occurrence times of troubles of the metal lead 137 can be reduced. Moreover, since the receiver flexible printed circuit 130 is attached so as to be interposed between the terminal portion 113 and the lead fixing portion 136, the flexible printed circuit can be connected with more sufficient strength.

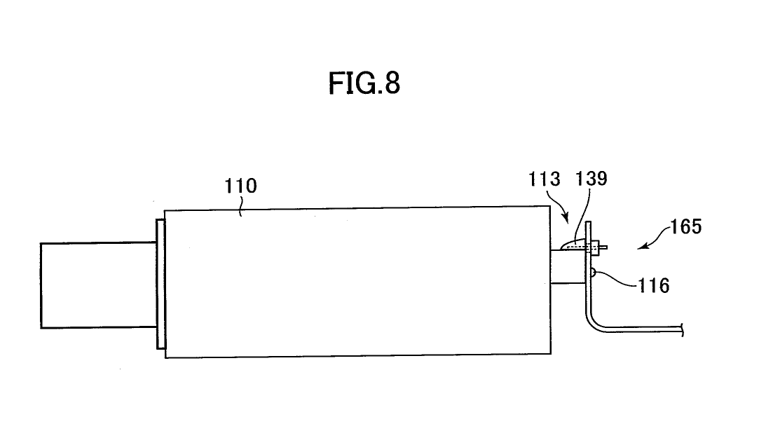

FIG. 8 is a diagram showing a modified example of the embodiment described above. In the embodiment described above, the metal leads 137 are formed in two rows so as to be able to interpose the terminal portion 113 in the lead fixing portion 136. However, in the modified example of FIG. 8, the terminal portion 113 is formed only on one surface of the receiver module substrate 112. In accordance with this configuration, the metal leads 137 are aligned in one row to be fixed to the lead fixing portion 136. Even with such a configuration, advantageous effects similar to those of the embodiment described above can be obtained. In the modified example, when the connection strength of the receiver flexible printed circuit 130 is insufficient, the lead fixing portion 136 may be fixed to the receiver module substrate 112 with a screw 116 or the like.

In the embodiment described above, the receiver flexible printed circuit 130 is configured so as to be interposed between the terminal portion 113 and the lead fixing portion 136. However, the lead fixing portion 136 may be arranged between the terminal portion 113 and the receiver flexible printed circuit 130.

In the embodiment described above, an example of using the receiver optical sub-assembly 110 has been described. However, the same applies to the case of using the transmitter optical sub-assembly 104, so that the configuration of the invention can be applied.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An optical module comprising:
an optical module main body including an optical connector to which a communication cable transferring optical signal is connected, and a terminal portion on which a plurality of terminal pads for transmitting or/and receiving an electric signal for communication using the optical signal are arranged;
a lead array including a lead fixing portion that retains a plurality of metal leads arranged in parallel on and protruding from the lead fixing portion and electrically connected to the plurality of terminal pads of the terminal portion; and
a flexible printed circuit including a plurality of holes through which the plurality of metal leads penetrate, and wires electrically connected to the metal leads.

2. The optical module according to claim 1, wherein
the plurality of terminal pads are formed on each of both surfaces of a circuit board, and
the plurality of metal leads of the lead array are fixed to the lead fixing portion in two rows distant from each other by an amount corresponding to the thickness of the circuit board, and electrically connected to the plurality of terminal pads via the plurality of holes of the flexible printed circuit.

3. The optical module according to claim 1, wherein
the flexible printed circuit further includes a circular conductive film that is a conductive film formed so as to surround each of the plurality of holes, and
the terminal pad of the optical module main body, the metal lead, and the circular conductive film of the flexible printed circuit are brazed with a conductive member.

4. The optical module according to claim 1, wherein
the pitch of the plurality of terminal pads is 0.6 mm or less.

5. The optical module according to claim 1, wherein
the flexible printed circuit is interposed between the terminal portion and the lead fixing portion.

6. The optical module according to claim 1, wherein
the flexible printed circuit further includes one of surfaces on which a wire that transmits at least a high-frequency signal is disposed, and the other surface on which a wire that supplies at least a fixed potential is disposed, and
the one surface of the flexible printed circuit is arranged on the terminal portion side, and the other surface is arranged on the lead fixing portion side.

7. An optical transceiver comprising:
a receiver optical sub-assembly that receives an optical signal and outputs an electric signal; and
a transmitter optical sub-assembly that receives an electric signal and outputs an optical signal, wherein
any of the receiver optical sub-assembly and the transmitter optical sub-assembly includes
an optical module main body including an optical connector to which a communication cable transferring optical signal is connected, and a terminal portion on which a plurality of terminal pads for transmitting or/and receiving an electric signal for communication using the optical signal are arranged,
a lead array including a lead fixing portion that retains a plurality of metal leads arranged in parallel on and protruding from the lead fixing portion and electrically connected to the plurality of terminal pads of the terminal portion, and
a flexible printed circuit including a plurality of holes through which the plurality of metal leads penetrate, and wires electrically connected to the metal leads.
